(19) United States
(12) Patent Application Publication
(10) Pub. No.: US 2015/0197107 A1
(43) Pub. Date: Jul. 16, 2015

(54) PRINTERS HAVING A STATIONARY PRINT HEAD AND RELATED METHODS

(71) Applicant: Toshiba Global Commerce Solutions Holdings Corporation, Tokyo (JP)

(72) Inventors: Richard H. Harris, Raleigh, NC (US); Kevin Vorhees, Raleigh, NC (US)

(73) Assignee: Toshiba Global Commerce Solutions Holdings Corporation, Tokyo (JP)

(21) Appl. No.: 14/194,986

(22) Filed: Mar. 3, 2014

Related U.S. Application Data
(60) Provisional application No. 61/926,339, filed on Jan. 12, 2014.

(51) Int. Cl. B41J 11/42

(52) U.S. Cl. CPC B41J 11/42

(57) ABSTRACT

Printers having a stationary print head and related methods are disclosed. According to an aspect, a printer includes a body defining a slot for movement of paper substantially within a plane. The printer also includes a stationary print head positioned adjacent to the slot. Further, the printer includes a first paper feed system configured to move the paper within the slot in a first direction. The printer also includes a second paper feed system configured to move the paper within the slot in a second direction.

### CROSS REFERENCE TO RELATED APPLICATION

This application claims the benefit of U.S. Provisional Patent Application No. 61/926,339, filed Jan. 12, 2014 and titled PRINTERS HAVING A STATIONARY PRINT HEAD AND RELATED METHODS, the content of which is hereby incorporated herein by reference in its entirety.

### TECHNICAL FIELD

The present invention relates to printers, and more specifically, to printers having a stationary print head and related methods.

### BACKGROUND

Document printers can be large and expensive. Particularly, the print head transport for document printers can have substantial width requirements. In addition, the transport systems require expensive drive motors, a home sensor, a precision shaft/bushing guide, and precise gap adjustments that are complex because the print head gap must be maintained over the entire range of transport motion. The width of a document printer is generally determined by the length of the print line, the print head heat sink width on each side of the print elements, and the width needed to accelerate and decelerate the mass of the print head, plus the printer cover and other structures. There is a desire to provide document printers that are smaller and less expensive to manufacture. Particularly, in retail environments, it is desired to provide smaller printers for reducing space consumption at point-of-sale areas.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are printers having a stationary print head and related methods. According to an aspect, a printer includes a body defining a slot for movement of paper substantially within a plane. The printer also includes a stationary print head positioned adjacent to the slot. Further, the printer includes a first paper feed system configured to move the paper within the slot in a first direction. The printer also includes a second paper feed system configured to move the paper within the slot in a second direction.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a perspective view of an example printer having a stationary print head in accordance with embodiments of the present invention;

FIG. 2 is a perspective cut-away view of the example printer shown in FIG. 1;

FIG. 3 is a top view of internal components of the printer shown in FIG. 1 in accordance with embodiments of the present invention;

FIG. 4 is an isometric internal view of mechanisms of the printer shown in FIG. 1 for feeding the document horizontally and vertically;

FIG. 5 is another isometric internal view of the printer shown in FIG. 1; and

FIG. 6 is another isometric internal view of the printer shown in FIG. 1.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

As referred to herein, the term “computing device” should be broadly construed. It can include any type of device including one or more electronic components. For example, a computing device including hardware, software, firmware, the like, and combinations thereof. A computing device may include one or more processors and memory or other suitable non-transitory, computer readable storage medium having computer readable program code for implementing methods in accordance with embodiments of the present invention. A computing device may be, for example, retail equipment such as POS equipment. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD). A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable computing device, such as a computer.

As referred to herein, the term “printer” should be broadly construed. It can include any type of device operable to make a representation of an electronic document on physical media. Exemplary printers include, but are not limited to, toner-based printers (e.g., laser printers), liquid inkjet printers, and solid ink printers. A printer may be a peripheral device for a computing device. For example, a printer may be communicatively connected to a point-of-sale computing device for printing receipts and other documents related to a retail transaction.

In accordance with embodiments of the present invention, a printer may include a body or cover defining a slot that extends substantially along a plane. Paper for print may be moved within the plane of the slot. More particularly, a portion or the entirety of the paper may be moved within the plane of the slot. The printer may include a stationary print head positioned adjacent to the slot for printing on the paper. Further, the printer may include two or more paper feed systems for moving the paper in two or more different directions. The paper feed systems may move the paper in at least two directions that are substantially perpendicular with respect to each other.

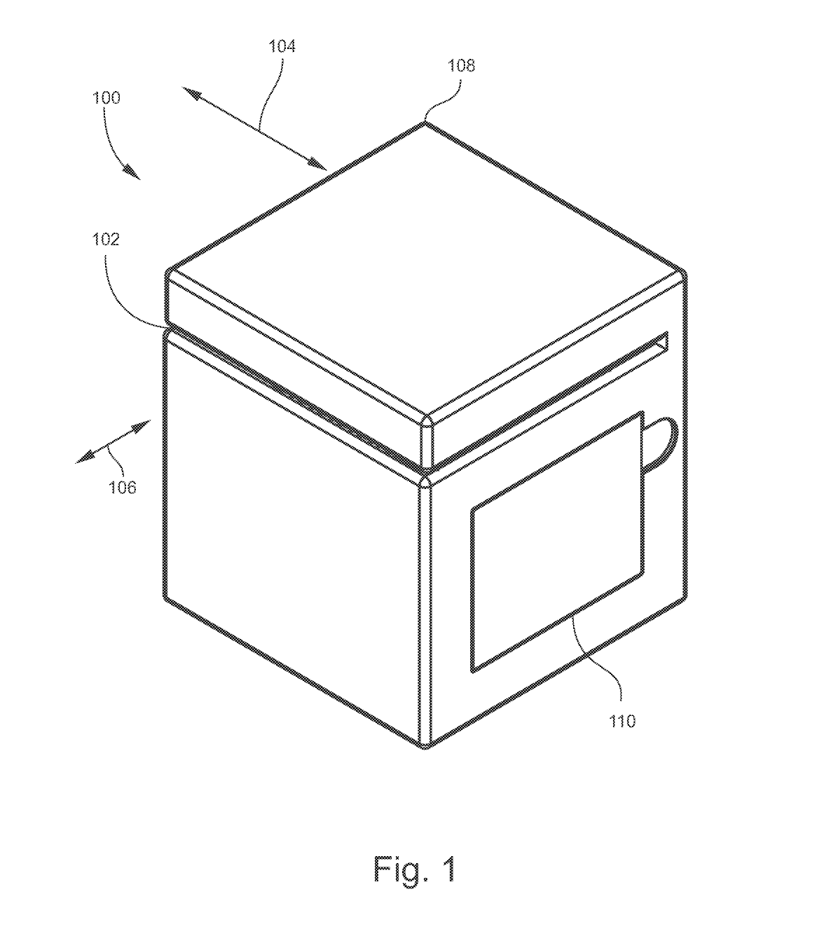

FIG. 1 illustrates a perspective view of an example printer 100 having a stationary print head in accordance with embodiments of the present invention. The printer 100 includes a slot 102 for receipt and print of document paper. The printer 100 may include paper feed systems that are described in further detail herein. The paper feed systems are configured to move the document paper along a plane substantially aligned with the slot 102. In this example, one of the paper feed systems can move the paper document forward and backward (vertically), as indicated by double-sided arrows 104, of the printer 100 and within the slot 102. Further, the other paper feed system can move the paper document side-to-side (horizontally), as indicated by double-sided arrows 106, of the printer 100 and within the slot 100. A stationary print head may be positioned adjacent the slot 102 such that the stationary print head may print on a nearby area of the paper document as will be understood by those of skill in the art.

The printer 100 may include cover or body 108 for housing internal components. The cover 108 may be removed so that an ink cartridge can be replaced and the printer 100 serviced. The printer 100 includes an access door 110 that can open and close for access to the internal components including the ink cartridge.

The printer 100 shown in FIG. 1 can overcome the shortcomings of conventional printers. In an example, printers disclosed herein can include a horizontal paper feed system to avoid use of a movable print head. In addition, printers disclosed herein can use tandem feed roller systems and a cooling fan for the stationary impact print head, Further, for example, disclosed herein are compact printers having a stationary, multiple wire, impact print head set at a 45 degree angle and a horizontal and vertical paper feed. A ribbon drive motor can power a fan that cools the stationary print head. Tandem paper feed rollers can ensure media stability and control. In other examples, printers disclosed herein may include an image scanner and a magnetic ink character recognition (MICR) read head can provide additional functionality. Components for implementing these functions are described in more detail herein.

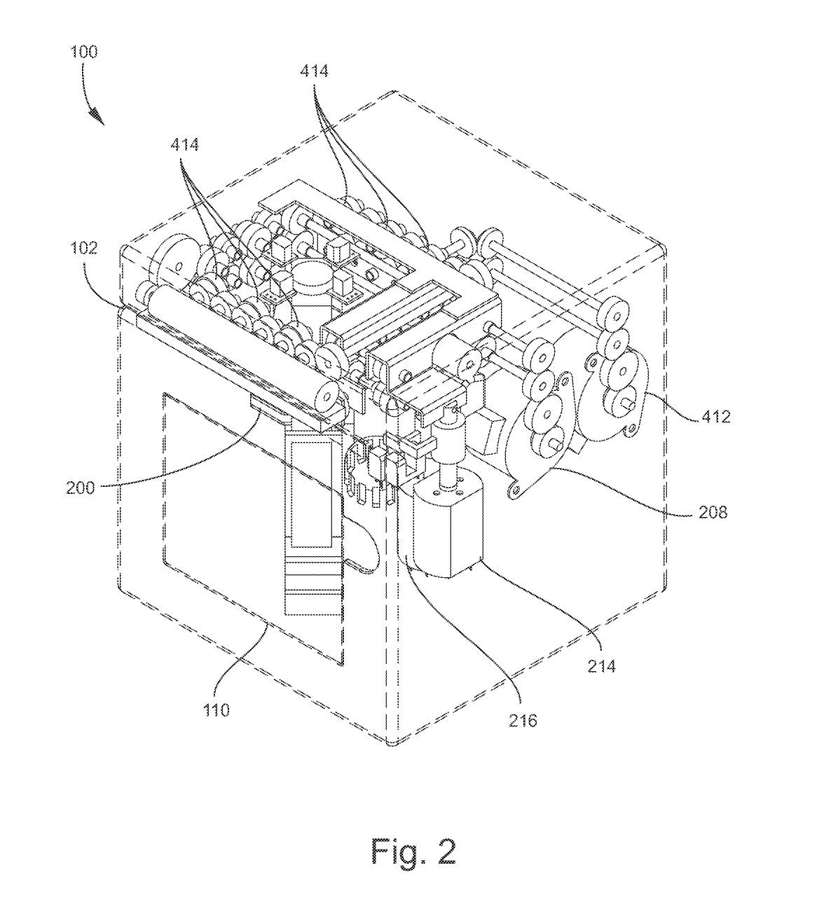

FIGS. 2-6 illustrate different views of the printer 100 shown in FIG. 1 and its internal components. Particularly, FIG. 2 illustrates a perspective cut-away view showing internal components of the printer 100. Referring to FIG. 2, the cover 108 is depicted as being transparent to show the relation of the cover 108 with respect to the internal components. The cover 108 may be suitably attached to the internal components, such as by a frame, as will be understood to those of skill in the art. The printer 100 includes a stationary impact print head 200. The print head 200 may interact with an ink-soaked ribbon for printing on paper. The print head 200 may be positioned near the slot 102 for printing on a nearby portion of paper as the paper is moved by the paper feed systems in different directions indicated by arrows 104 and 106. Alternatively, the printer 100 may utilize any other suitable stationary print head or system for printing to paper. The ribbon may be accessed and serviced by opening the access door 110.

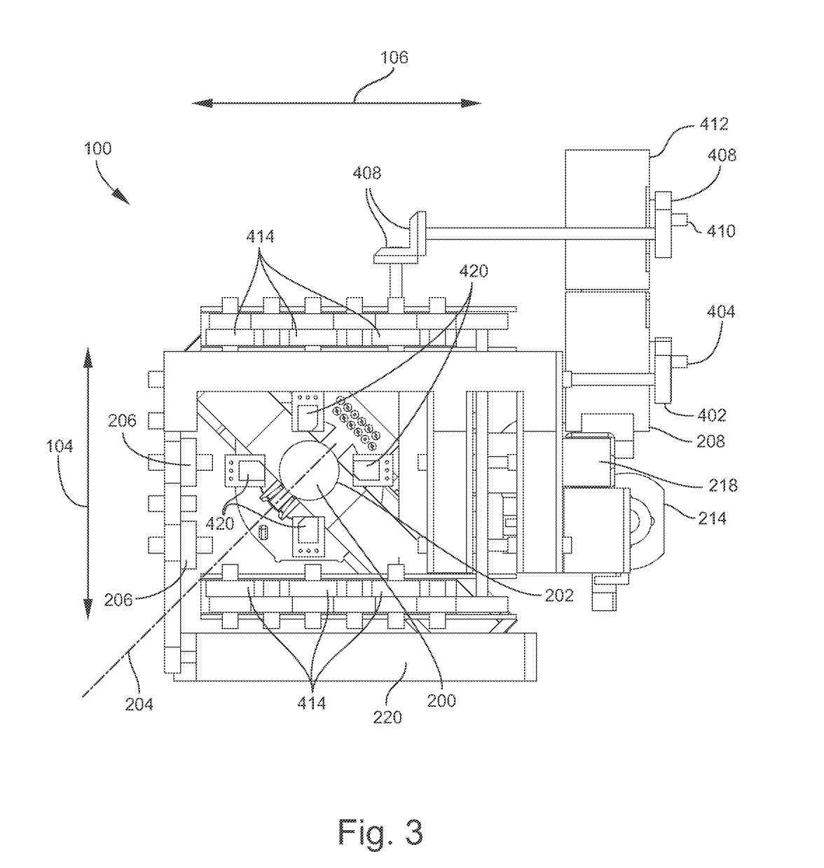

FIG. 3 illustrates a top view of internal components of the printer 100 shown in FIGS. 1 and 2. Referring to FIGS. 2 and 3, the print head 200 is angled to allow for bi-directional printing. The printer 100 includes an impact platen 202 positioned in proximity to the print head 200. Line 204 indicates a center line of print wires. The print head 200 may be controlled to print on paper as the paper is moved along directions 104 and 106 and is suitably positioned for printing at a desired position on the paper. The printer 100 may include multiple vertical feed rollers 206 operatively configured for turn by a vertical paper feed motor 208 for grasping the paper between upper and lower rollers 206 and for moving the paper along the vertical direction 104. Upper and lower rollers 206 may define nip points for grasping the paper when engaged. Conversely, upper and lower rollers 206 may disengage to release the paper from the rollers 206. The vertical paper feed motor 208 may be a stepper motor or any other suitable type of motor.

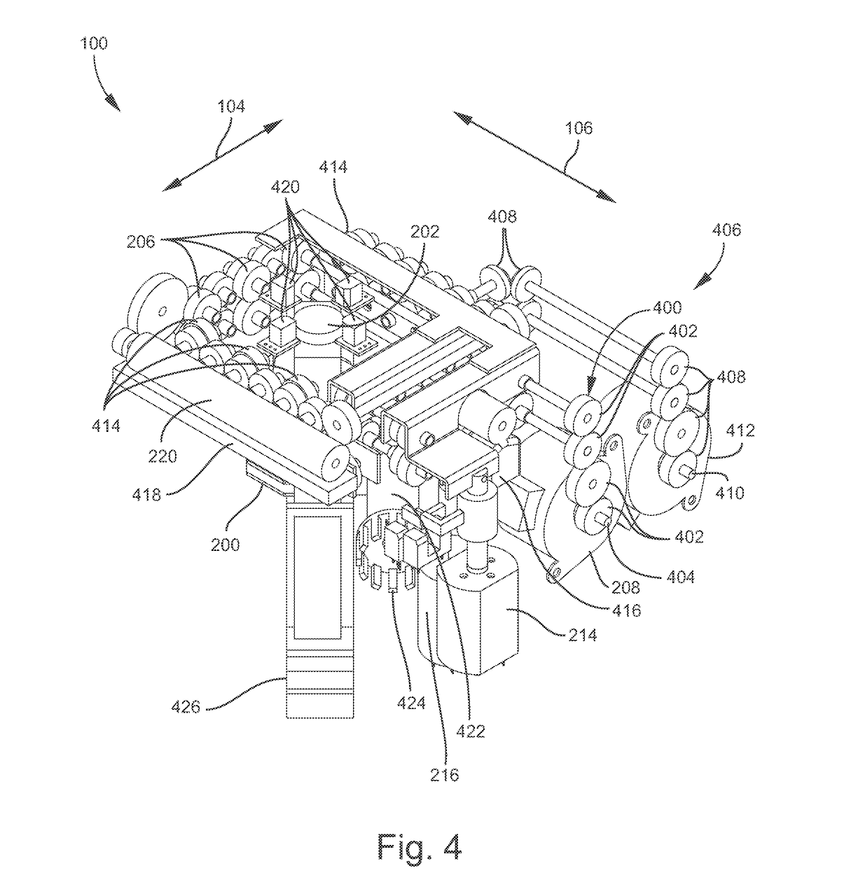

Referring particularly to FIG. 4, the printer 100 may include a gear train 400 including multiple gears 402 and shafts operatively attached to a frame of the printer 100 for transmission of rotation of a shaft 404 of the vertical paper feed motor 208 to the vertical feed rollers 206. The vertical paper feed motor 208 may be suitably operated by a control system to turn for controlling movement of the paper along the direction 104. The printer 100 may alternatively be configured with any other suitable mechanism for turning the vertical feed rollers 206.

The printer 100 may include another gear train 406 including multiple gears 408 and shafts operatively attached to the frame of the printer 100 for transmission of rotation of a shaft 410 of a horizontal paper feed motor 412 to horizontal feed rollers 414. Upper and lower rollers 414 may define nip points for grasping the paper. The motor 412 may be stepper motor or any other suitable type of motor. A suitable control system may operate the horizontal paper feed motor 412 to turn for controlling the movement of the paper along the horizontal direction 106. It is noted that the printer 100 may include any other suitable mechanism for turning the horizontal feed rollers 414. Alternately, a single feed motor may be coupled via a transmission so that it feeds either vertical or horizontal paper feed rollers.

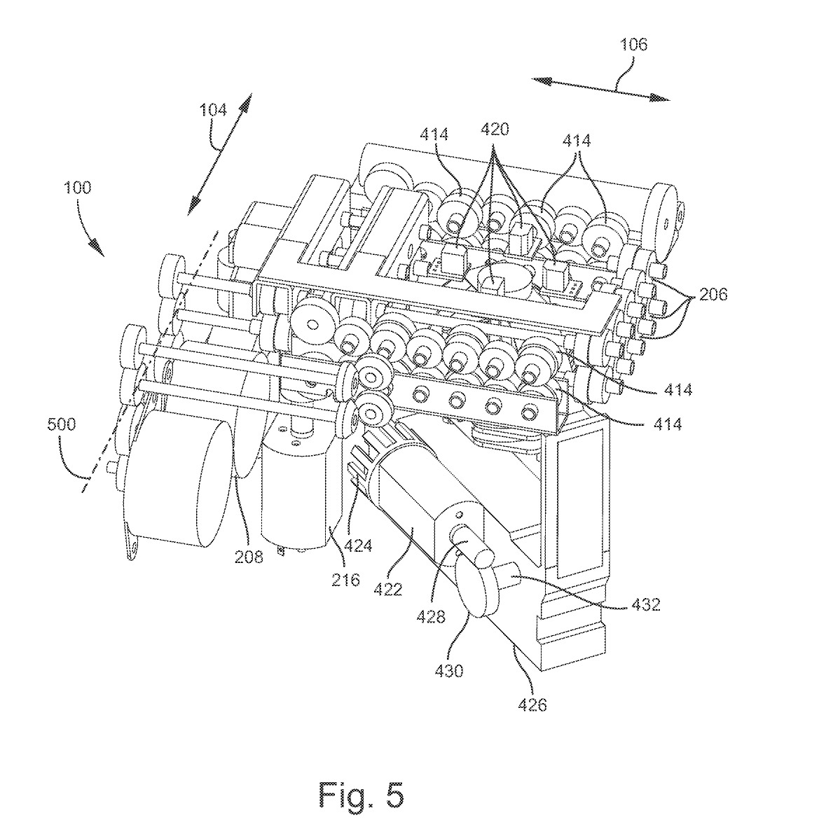

The printer 100 may include a vertical paper feed disengage motor 214 and a horizontal paper feed disengage motor 216 configured to control mechanisms for disengaging the vertical feed rollers 206 and the horizontal feed rollers 414, respectively, from the paper. For example, FIG. 5 illustrates another isometric internal view of the printer 100 shown in FIG. 1. Referring to FIG. 5, the figure shows the horizontal paper feed mechanism as being disengaged. The horizontal paper feed disengage motor 216 can operate to pull downward on the lower set of horizontal feed rollers 414 for causing a gap between these rollers 414 to allow the paper to move vertically 104. For example, the motor 216 may be activated to control another mechanism for disengaging the horizontal feed rollers 414 from the paper. A pivot axis of the mechanism for disengaging the horizontal feed rollers 414 is indicated by line 500. By pivoting the mechanism on the axis 500, the vertical feed rollers 206 may be allowed to engage the paper so that the vertical feed rollers 206 can operate to move the paper in the vertical direction 104.

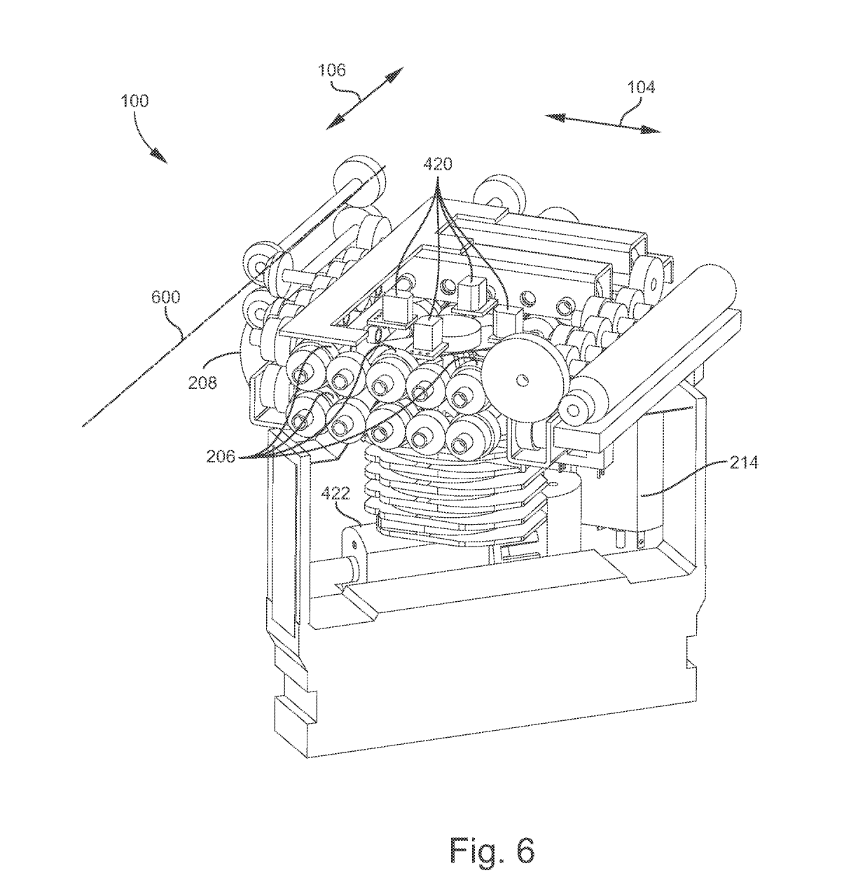

FIG. 6 illustrates another isometric internal view of the printer shown in FIG. 1. Referring to FIG. 6, the figure shows the vertical paper feed mechanism as being disengaged. The vertical paper feed disengage motor 214 can operate to push upward on the common frame that supports all the top vertical paper feed rollers 206. This frame can rotate about the pivot axis 600 as shown. All the lower vertical feed rollers 206 can be attached to a common frame that is free to rotate about the pivot axis 600 as shown. For example, the vertical paper feed disengage motor 214 may be activated to control a mechanism for disengaging the vertical feed rollers 206 from the paper. By disengagement of the vertical feed rollers 206, the horizontal feed rollers 414 may be allowed to engage the paper so that the horizontal feed rollers 414 can operate to move the paper in the horizontal direction 106.

The printer 100 may shift from vertical printing to horizontal printing, and the rollers may be simultaneously engaged so that the paper is never disengaged from the feed rollers until printing is complete. In this example, the disengage system of the printer 100 may be a lead screw system that can maintain its position even when the motor is inactive. Alternatively, any other suitable system for lifting the rollers may be utilized, including a system wherein both disengage systems might share a single motor. A normal condition of the printer 100 between transactions may be with both feed systems disengaged (open throat) or with the vertical feed engaged and the paper inserted in front of the first vertical feed roller 206. One or more of the sensors 420 may sense and indicate the presence of the paper. This feed roller arrangement can allow printing right up to the edge of document. This is possible because there is a feed roller in line with the print wires 204 in both feed directions.

In accordance with embodiments of the present invention, the printer 100 may include MICR reading and image sensing functionality. Referring to FIGS. 3 and 4, the printer 100 may include a MICR read head 416 configured and positioned for scanning and reading information on paper. For example, the MICR read head 416 may be configured to read MICR characters on the paper. The MICR read head 416 may generate a signal representative of the MICR characters and may suitably communicate data of the MICR characters to a computing device. Further, the printer 100 may include a MICR platen 218 for carrying the paper and for positioning the paper in a suitable position near the MICR read head 416.

In accordance with embodiments of the present invention, the printer 100 may include an image sensor 418 for capturing an image of the paper. For example, the image sensor 418 may be configured to capture one or more images of the paper and generate data representative of the image(s). Subsequently, the image sensor 418 may suitably communicate the image data to a computing device. Further, the printer 100 may include image sensor platen 220 for carrying the paper and for positioning paper in a suitable position near image sensor 418.

In accordance with embodiments of the present invention, the printer 100 may include multiple paper edge sensors 420 positioned around the print head 200. In this example, the printer 100 includes four edge sensors, although it should be understood that the printer may include any suitable number of edge sensors in any suitable configuration. The edge sensors 420 may detect when a paper edge is near the print head 200 for recognizing a surface of the paper for print. The edge sensors 420 may generate signals for indicating a paper edge and the print head 200 may be controlled for print based on the detected paper edges to locate the printed image on the paper.

In accordance with embodiments of the present invention, the printer 100 may include ribbon feed/fan motor 422 configured to turn a fan 424 for cooling internal components of the printer 100 and for turning a ribbon cartridge 426 for dispensing ink. A shaft 428 of the motor 422 may be directly connected to the fan 422 for turning the fan 424. The shaft 428 may turn a gear 430 that is directly connected to the ribbon cartridge 426 via a shaft 432. Alternatively, any suitable mechanism may be utilized for operatively connecting the motor 422 to the fan 424 and the ribbon cartridge 426. In this way, the motor 422 can also provide the function of cooling the stationary print head 200.

Control of the components of the printers disclosed herein may be suitably implemented as a system, a method, and/or a computer program product. For example, suitable hardware, software, firmware, or combinations thereof may be utilized for implementing the control systems disclosed herein. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

1. A printer comprising:
a body defining a slot for movement of paper substantially within a plane;
a stationary print head positioned adjacent to the slot;
a first paper feed system configured to move the paper within the slot in a first direction; and
a second paper feed system configured to move the paper within the slot in a second direction, wherein the first direction is substantially perpendicular to the second direction within the plane.

2. The printer of claim 1, wherein the slot extends substantially along the plane.

3. (canceled)

4. The printer of claim 1, wherein the first and second paper feed systems each include at least one feed roller.

5. The printer of claim 1, wherein the first and second paper feed systems each share a single motor.

6. The printer of claim 1, further comprising a controller communicatively connected to the stationary print head and the first and second paper feed systems, and configured to output control signals to the stationary print head and the first and second paper feed systems.

7. The printer of claim 6, wherein the controller is configured to:
determine an edge of the paper along the first direction;
determine an edge of the paper along the second direction;
control the first paper feed system to move the paper in the first direction based on the determined edge of the paper along the first direction; and
control the second paper feed system to move the paper in the second direction based on the determined edge of the paper along the second direction.

8. The printer of claim 1, wherein the first paper feed system is disengaged from moving the paper when the second feed system is moving the paper.

9. The printer of claim 1, wherein the second paper feed system is disengaged from moving the paper when the first feed system is moving the paper.

10. The printer of claim 1, further comprising a document sensor configured to sense a presence of the paper within the slot.

11. The printer of claim 1, further comprising a ribbon drive motor configured to cool the stationary print head.

12. A method comprising:
providing a printer comprising:
a body defining a slot for movement of paper substantially within a plane;
a stationary print head positioned adjacent to the slot;
a first paper feed system configured to move the paper within the slot in a first direction; and
a second paper feed system configured to move the paper within the slot in a second direction, wherein the first direction is substantially perpendicular to the second direction within the plane; and
communicating output control signals to the stationary print head and the first and second paper feed systems.

13. The method of claim 12, wherein the slot extends substantially along the plane.

14. (canceled)

15. The method of claim 12, wherein the first and second paper feed systems each include at least one feed roller.

16. The method of claim 12, further comprising:
determining an edge of the paper along the first direction;
determining an edge of the paper along the second direction;
controlling the first paper feed system to move the paper in the first direction based on the determined edge of the paper along the first direction; and
controlling the second paper feed system to move the paper in the second direction based on the determined edge of the paper along the second direction.

17. The method of claim 12, further comprising controlling the first paper feed system to disengage from moving the paper when the second feed system is moving the paper.

18. The method of claim 12, further comprising controlling the second paper feed system to disengage from moving the paper when the first feed system is moving the paper.

19. The method of claim 12, wherein the printer further comprises a document sensor configured to sense a presence of the paper within the slot.

20. The method of claim 12, wherein the printer further comprises a ribbon drive motor configured to cool the stationary print head.
